(19) United States
(12) Patent Application Publication
(10) Pub. No.: US 2025/0210913 A1
(43) Pub. Date: Jun. 26, 2025

(54) CONNECTOR AND CONNECTOR UNIT

(71) Applicant: SUMITOMO WIRING SYSTEMS, LTD., Mie (JP)

(72) Inventor: Kentaro HIRAI, Mie (JP)

(21) Appl. No.: 18/978,574

(22) Filed: Dec. 12, 2024

(30) Foreign Application Priority Data
Dec. 21, 2023 (JP) 2023-215533

(51) Int. Cl. H01R 13/627

(52) U.S. Cl. CPC H01R 13/6273

(57) ABSTRACT

A connector 10 includes a terminal fitting 90 with a tab 91, and a hood portion 20 inside which the tab 91 protrudes. One connector 10A of two connectors 10A and 10B includes, on the hood portion 20, a first latching portion 32 protruding forward beyond an opening edge of the hood portion 20. The other connector 10B includes a second latching portion 33. Due to the first latching portion 32 of the one connector 10A being locked to the second latching portion 33 of the other connector 10B, the two connectors 10A and 10B are arranged in a state in which the opening edges thereof are abutted against each other.

### CROSS-REFERENCE TO RELATED APPLICATIONS

This application is based on and claims priority from Japanese Patent Application No. 2023-215533, filed on Dec. 21, 2023, with the Japan Patent Office, the disclosure of which is incorporated herein in its entirety by reference.

### TECHNICAL FIELD

The present disclosure relates to a connector and a connector unit.

### BACKGROUND

A connector disclosed in JP 2023-117578A includes a male terminal with a tab, a hood portion inside which the tab protrudes, and a moving plate attached inside the hood portion. Before the connector is fitted to a counterpart connector, the moving plate positions the tab inside the hood portion. Even if foreign matter enters the hood portion before the fitting of the connector, the foreign matter comes into contact with the moving plate, thus making it possible to avoid the breakage and the like of the tab. JP S54-036787U discloses a technology for coupling the side surfaces of two housings to each other.

### SUMMARY

In JP 2023-117578A, every connector includes the moving plate, and there is a concern of an increase in the cost compared with a connector provided with no moving plate. In addition, it is necessary to ensure a space in which the moving plate can be attached inside the hood portion, and therefore, it is difficult to apply such a configuration to a small-sized connector. In contrast, if the connector does not include the moving plate, there is a problem in that the tab cannot be protected.

Therefore, it is an object of the present disclosure to provide a connector and a connector unit capable of protecting the tab and enabling a reduction in size and cost.

A connector of the present disclosure is a connector including: a terminal fitting with a tab; and a hood portion inside which the tab protrudes, wherein the hood portion includes a first latching portion and a second latching portion having shapes capable of being locked to each other, the first latching portion includes a portion protruding forward beyond an opening edge on a front surface of the hood portion, and the first latching portion and the second latching portion are located at positions symmetrical about a point or with respect to a line when the hood portion is viewed from a front side.

A connector unit of the present disclosure is a connector unit including two connectors of the same type or different types, wherein each of the two connectors includes: a terminal fitting with a tab; and a hood portion inside which the tab protrudes, one connector of the two connectors includes, on the hood portion, a first latching portion having a portion protruding forward beyond an opening edge on a front surface of the hood portion, and the other connector includes a second latching portion, and in a state in which the opening edges of the two connectors are abutted against each other, the first latching portion of the one connector is locked to the second latching portion of the other connector.

With the present disclosure, it is possible to provide a connector and a connector unit capable of protecting the tab located inside the hood portion and enabling a reduction in size and cost.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in Embodiment 1.

FIG. 2 is a front view of one of two coupled connectors in Embodiment 1 with the other connector being indicated by two-dot chain lines.

FIG. 3 is a perspective view of a connector unit formed by coupling two connectors in Embodiment 1.

FIG. 4 is a side cross-sectional view of the connector unit formed by coupling two connectors in Embodiment 1.

FIG. 5 is a front view of a connector in Embodiment 2.

FIG. 6 is a plan view showing a connector unit formed by coupling two connectors in Embodiment 2, with a coupling portion where the two connectors are coupled being fractured.

FIG. 7A is a front view of a first connector in Embodiment 3.

FIG. 7B is a front view of a second connector in Embodiment 3.

FIG. 8 is a side cross-sectional view of a connector unit formed by coupling the first connector and the second connector in Embodiment 3.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.
(1) A connector of the present disclosure includes: a terminal fitting with a tab; and a hood portion inside which the tab protrudes, wherein the hood portion includes a first latching portion and a second latching portion having shapes capable of being locked to each other, the first latching portion includes a portion protruding forward beyond an opening edge on a front surface of the hood portion, and the first latching portion and the second latching portion are located at positions symmetrical about a point or with respect to a line when the hood portion is viewed from a front side.

For example, at the time of transfer or the like during a harness production process, when the opening edges of two connectors are abutted against each other, the first latching portion of one connector can be locked to the second latching portion of the other connector and the second latching portion of the one connector can be locked to the first latching portion of the other connector. This makes it possible to couple the two connectors to each other. The tabs are disposed inside the hood portions of the coupled connectors in a state in which the tabs are protected from foreign matter from the outside. Accordingly, with the configuration of (1) above, the tab located inside the hood portion can be protected even if the connector does not include the moving plate. Since the connector does not include the moving plate, the cost can be accordingly reduced, and this configuration is also applicable to a small-sized connector. Note that the “locking” in the description above refers to a state in which two connectors whose opening edges have been abutted against each other are latched to each other so as to remain coupled to and not to separate from each other.
(2) It is preferable that, in the connector according to (1) above, the first latching portion has a protruding shape that protrudes from the opening edge, and the second latching portion is formed at the opening edge and has a recessed shape to which the first latching portion is fittable.

With the configuration of (2) above, when the first latching portion and the second latching portion are formed, it is unnecessary to process elastic locks and the like, and the processability is excellent. Also, it is possible to couple the two connectors simply by abutting the opening edges of the two connectors against each other.
(3) It is preferable that, in the connector according to (2) above, at least one surface of an exterior circumferential surface of the first latching portion and an interior circumferential surface of the second latching portion is provided with a press-fitting rib having a shape capable of coming into contact with the other surface.

With the configuration of (3) above, the force with which the first latching portion and the second latching portion are locked (coupled) to each other can be improved without complicating the shapes of the first latching portion and the second latching portion.
(4) It is preferable that, in the connector according to any one of (1) to (3) above, a plurality of pairs of the first latching portion and the second latching portion are provided, and the first latching portion and the second latching portion of each pair are located at positions symmetrical about a center of the opening with the center being a rotation center.

With the configuration of (4) above, a plurality of pairs of one first latching portion and one second latching portion can improve the reliability with which the two connectors remain coupled to each other when the opening edges of the connectors are abutted against each other.
(5) It is preferable that, in the connector according to (4) above, the first latching portion is located on any one side of an upper side, a lower side, a left side, and a right side of the opening edge, and the second latching portion is located on the other side opposite to the one side of the opening edge.

With the configuration of (5) above, an operator can easily recognize the orientation of the connector with respect to the vertical direction and the left-right direction by checking the positions of the first latching portion and the second latching portion at the opening edge of the hood portion. As a result, it is possible to change the orientation of the connector to the corresponding orientation and fit it to a counterpart connector, thus making it possible to speed up the fitting operation.
(6) A connector unit of the present disclosure includes two connectors of the same type or different types, wherein each of the two connectors includes: a terminal fitting with a tab; and a hood portion inside which the tab protrudes, one connector of the two connectors includes, on the hood portion, a first latching portion having a portion protruding forward beyond an opening edge on a front surface of the hood portion, and the other connector includes a second latching portion, and in a state in which the opening edges of the two connectors are abutted against each other, the first latching portion of the one connector is locked to the second latching portion of the other connector.

For example, at the time of transfer or the like during a harness production process, two connectors of the same type or different types are coupled to each other via the first latching portions and the second latching portions by abutting the opening edges of the connectors against each other, and, inside the hood portions of the connectors, the tabs can be protected from foreign matter from the outside. The connector need not include the moving plate in order to protect the tab, thus making it possible to reduce the size and cost of the connector accordingly. Note that the “locking” in the description above refers to a state in which two connectors whose opening edges have been abutted against each other are latched to each other so as to remain coupled to and not to separate from each other.

### Details of Embodiments of the Present Disclosure

The following describes specific examples of the present disclosure with reference to the drawings. Note that the present invention is not limited to these examples and is defined by the scope of the appended claims, and all changes that fall within the same essential spirit as the scope of the claims are intended to be included therein.

### Embodiment 1

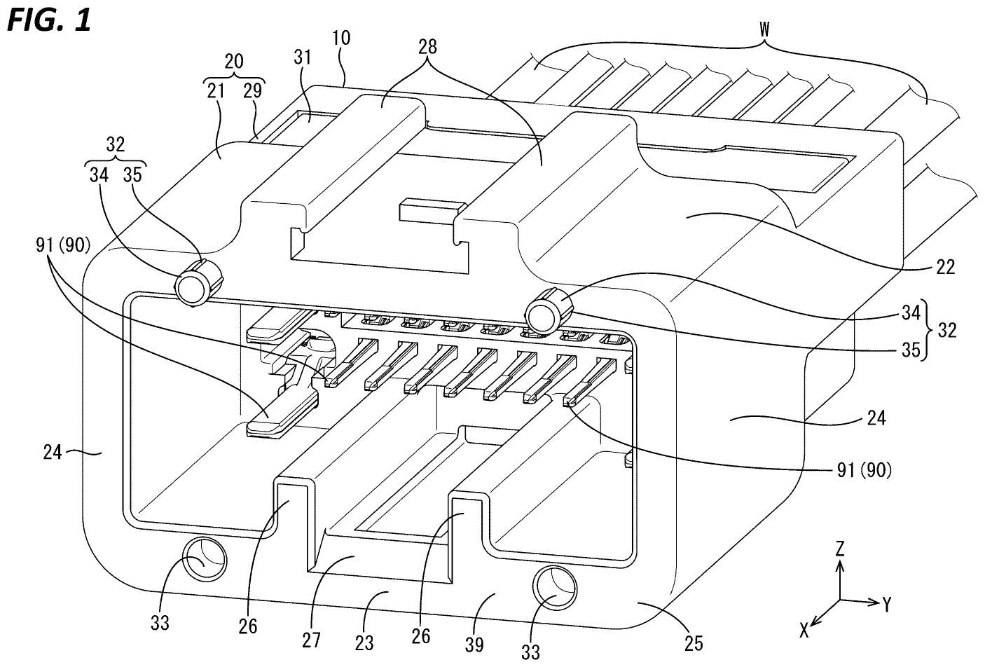

As shown in FIG. 1, a connector 10 of Embodiment 1 includes terminal fittings 90 each having a tab 91, and a hood portion 20 inside which the tabs 91 protrude. The connector 10 is an example of a male connector. The hood portion 20 can be fitted to a counterpart connector (female connector) (not illustrated). Note that, in the following description, the side from which the hood portion 20 is fitted to the counterpart connector is taken as the front side in the front-rear direction. The left-right direction is based on the left-right direction of FIG. 1. The vertical direction is based on the vertical direction of FIG. 1. In FIG. 1, the front-rear direction is indicated by a symbol “X”, the left-right direction is indicated by a symbol “Y”, and the vertical direction is indicated by a symbol “Z”. The reference directions do not necessarily coincide with the corresponding directions when the connector 10 is mounted in a vehicle or the like (not illustrated).

### Hood Portion 20 and Terminal Fitting 90)

The hood portion 20 is made of a synthetic resin and includes a fitting portion 21 having a polygonal-tube shape. The fitting portion 21 includes an upper wall portion 22 and a lower wall portion 23 that face each other in the vertical direction, and a pair of left and right side wall portions 24 that face each other in the left-right direction. The upper wall portion 22 and the lower wall portion 23 extend in the left-right direction. The side wall portions 24 extend in the vertical direction. Corner portions 25 are formed between the upper end portions of the side wall portions 24 and the left and right end portions of the upper wall portion 22 and between the lower end portions of the side wall portions 24 and the left and right end portions of the lower wall portion 23. A pair of guiding ribs 26 that are spaced apart from each other in the left-right direction protrude from the interior surface (the surface facing the upper wall portion 22) of the lower wall portion 23. The guiding ribs 26 extend in parallel with each other in the front-rear direction. The central portion in the left-right direction of the interior surface of the lower wall portion 23 is provided with a locking portion 27 that has a rib-like shape and extends between the guiding ribs 26. The counterpart connector is fitted into the hood portion 20 while being guided by the guiding ribs 26, and is locked to the locking portion 27. Accordingly, a state in which the counterpart connector is fitted into the hood portion 20 is maintained.

A pair of rail portions 28 that are spaced apart from each other in the left-right direction protrude from the exterior surface (the surface on the side opposite to the surface facing the lower wall portion 23) of the upper wall portion 22. The rail portions 28 extend in parallel with each other in the front-rear direction. The rail portions 28 are for attachment to a bracket (not illustrated). The connector 10 is supported by a vehicle body or the like via the bracket.

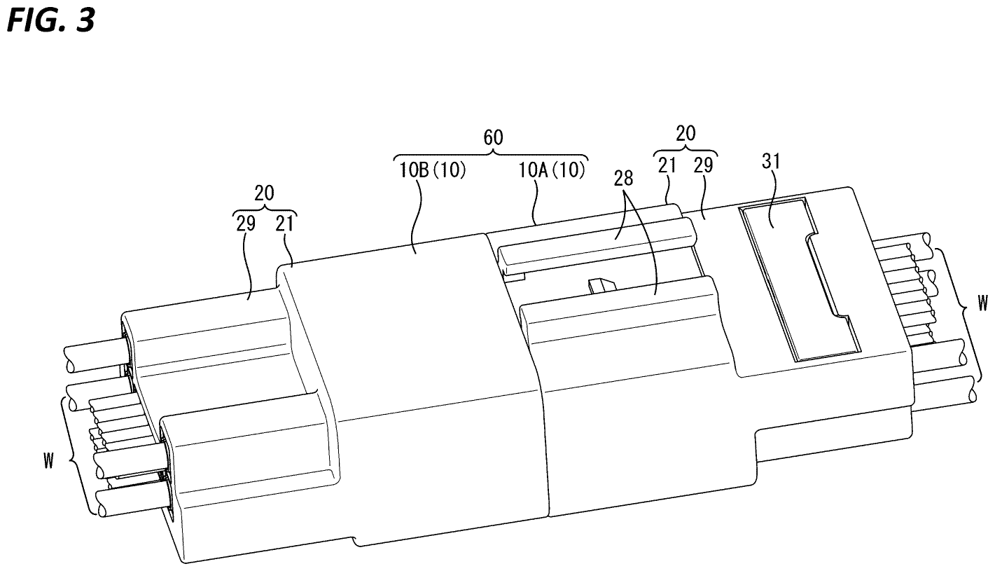

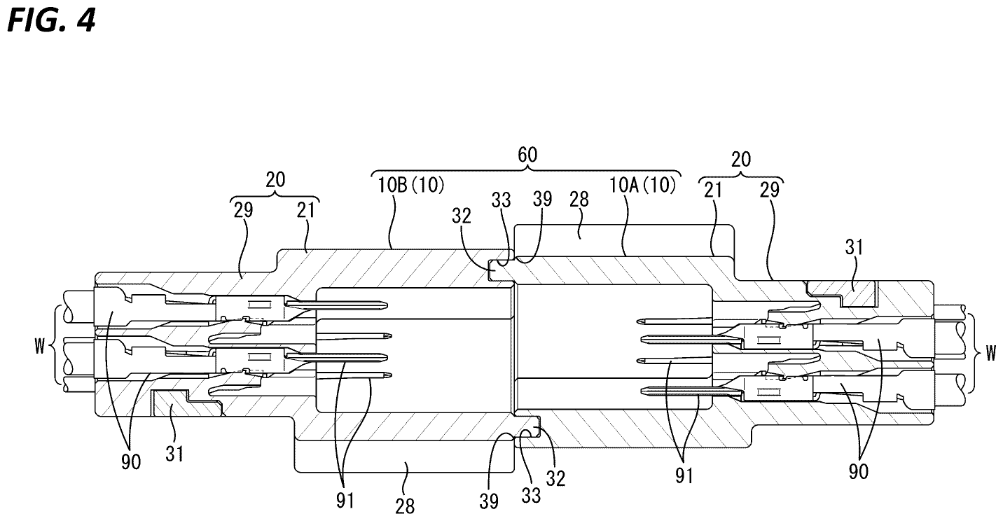

As shown in FIGS. 3 and 4, a terminal attachment portion 29 that is continuous with the fitting portion 21 is formed behind the fitting portion 21. As shown in FIG. 4, a plurality of terminal fittings 90 are attached to the terminal attachment portion 29. Each of the terminal fittings 90 is formed in one piece by, for example, bending a conductive metal plate material. The tab 91 protrudes from the front portion of the terminal fitting 90. The tab 91 of the terminal fitting 90 is disposed inside the hood portion 20. The rear portion of the terminal fitting 90 is connected to the terminal portion of an electric wire W. The electric wire W is drawn from the rear surface of the terminal attachment portion 29. A retainer 31 for preventing dislodgement of the terminal fittings 90 is attached to the terminal attachment portion 29.

As shown in FIG. 1, a front surface 39 (open end surface, leading end surface) of the hood portion 20 forms the opening edge of the hood portion 20, includes the front surfaces of the guiding ribs 26 and the rail portions 28, and is continuous over the entire periphery at one position in the front-rear direction. In this Embodiment 1, the front surface 39 of the hood portion 20 is arranged extending along the left-right direction and the vertical direction.

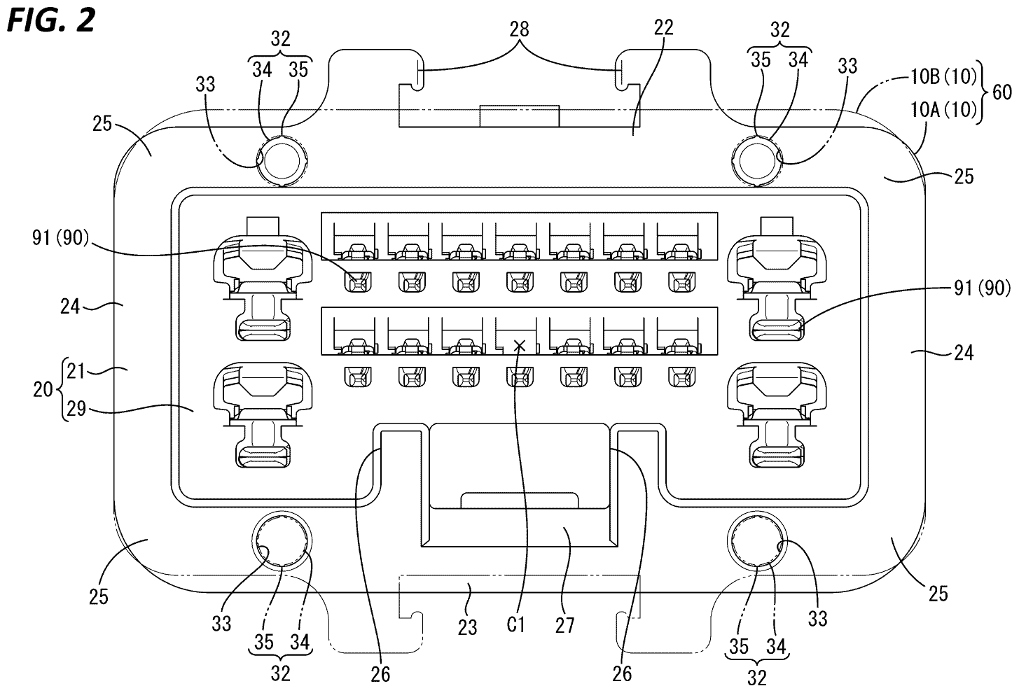

As shown in FIGS. 1 and 2, the front surface 39 of the hood portion 20 is provided with first latching portions 32 and second latching portions 33 that are spaced apart from one another in the peripheral direction. Each of the first latching portions 32 includes a latching main body 34 having a pin-like shape (specifically a columnar shape) that protrudes from the front surface 39 of the hood portion 20. The front surface of the latching main body 34 is an end surface extending along the left-right direction and the vertical direction. The exterior circumferential surface of the latching main body 34 extends continuously with a constant diameter in the front-rear direction, except for the front end portion. The diameter of the front end portion of the exterior circumferential surface of the latching main body 34 gradually decreases toward the end surface. The first latching portion 32 includes a plurality of press-fitting ribs 35 that protrude from the outer circumferential surface of the latching main body 34. Each of the press-fitting ribs 35 is a rib extending in the front-rear direction over the entire exterior circumferential surface of the latching main body 34 excluding the front end portion. The press-fitting ribs 35 are located at four positions at regular intervals in the circumferential direction of the exterior circumferential surface of the latching main body 34. Specifically, the press-fitting ribs 35 are located at the upper end portion, the lower end portion, the left end portion, and the right end portion of the exterior circumferential surface of the latching main body 34. The cross section (transverse section) of each press-fitting rib 35 perpendicular to the extension direction has a semicircular shape.

Each of the second latching portions 33 is formed as a recessed portion having a recessed shape (specifically a circular shape in a front view) that is recessed in the front surface 39 of the hood portion 20. The back end surface in the depth direction (the surface that is located at the rear end in the front-rear direction and faces forward) of the second latching portion 33 is arranged extending along the left-right direction and the vertical direction. The interior circumferential surface of the second latching portion 33 extends continuously with a constant diameter in the front-rear direction, except for the front end portion, which will be described later. The diameter of the front end portion of the interior circumferential surface of the second latching portion 33 gradually increases toward the front surface 39 of the hood portion 20. The second latching portion 33 is formed in a shape complementary to the shape of the first latching portion 32. In this Embodiment 1, the first latching portion 32 is fitted into the second latching portion 33. The press-fitting ribs 35 come into tight contact with the interior circumferential surface of the second latching portion 33 in a press-fitted state.

A plurality of first latching portions 32 protrude from the front surface 39 of the hood portion 20. Also, a plurality of second latching portions 33 are recessed in the front surface 39 of the hood portion 20, and the number of first latching portions 32 and the number of second latching portions 32 are the same. Specifically, the first latching portions 32 are formed at two positions spaced apart from each other in the left-right direction on the front surface 39 of the upper wall portion 22 of the hood portion 20. The second latching portions 33 are formed at two positions spaced apart from each other in the left-right direction on the front surface 39 of the lower wall portion 23 of the hood portion 20.

As shown in FIG. 2, the first latching portions 32 and the second latching portions 33 include two pairs of one first latching portion 32 and one second latching portion 33, and the first latching portion 32 and the second latching portion 33 in each pair are located as a pair at positions symmetrical about a center C1 of the opening of the hood portion 20 with the center C1 being a rotation center. Specifically, the first latching portion 32 on the right side on the front surface 39 of the upper wall portion 22 of the hood portion 20 and the second latching portion 33 on the left side on the front surface 39 of the lower wall portion 23 of the hood portion 20 are located as a pair at positions symmetrical about the center C1 of the opening with the center C1 being a rotation center in a front view of the hood portion 20. The first latching portion 32 on the left side on the front surface 39 of the upper wall portion 22 of the hood portion 20 and the second latching portion 33 on the right side on the front surface 39 of the lower wall portion 23 of the hood portion 20 are located as a pair at positions symmetrical about the center C1 of the opening with the center C1 being a rotation center in a front view of the hood portion 20.

### Effects of Connector 10

Before the connector 10 is fitted to a counterpart connector (e.g., at the time of transfer during a harness production process, or when the connector 10 is placed temporarily), two connectors 10A and 10B with the above-described structure are arranged in a state in which their openings face each other and one connector 10A is inverted 180 degrees relative to the other connector 10B in the vertical direction (see FIGS. 2 and 3). From this state, the front surfaces 39, which are the opening edges, of the hood portions 20 of the connectors 10A and 10B are abutted against each other. Then, as shown in FIGS. 2 and 4, the first latching portions 32 of the one connector 10A are fitted into the second latching portions 33 of the other connector 10B, and the first latching portions 32 of the other connector 10B are fitted into the second latching portions 33 of the one connector 10A. Here, the first latching portions 32 are press-fitted to the second latching portions 33 via the press-fitting ribs 35. As a result, a connector unit 60 is formed in which the connectors 10A and 10B are locked to each other in the state in which the front surfaces 39 of the hood portions 20 come into face-to-face contact with each other and the connectors 10A and 10B remain coupled to each other.

In the connector unit 60, the opening of the hood portion 20 of the one connector 10A is blocked by the other connector 10B, and the opening of the hood portion 20 of the other connector 10B is blocked by the one connector 10A. As a result, the insides of the hood portions 20 of the connectors 10A and 10B are sealed. A plurality of tabs 91 protrude inside the hood portions 20 of the connectors 10A and 10B. With this configuration, foreign matter from the outside of the connector 10 is prevented from entering the hood portion 20, thus making it possible to avoid the breakage of and damage to the tabs 91.

Prior to the completion of a harness, just before the connector 10 is fitted to a counterpart connector, a force is applied to the connectors 10A and 10B in a direction in which the connectors 10A and 10B are detached from each other to separate them from each other. The connectors 10A and 10B are then fitted to corresponding counterpart connectors.

As described above, the connector 10 of this Embodiment 1 includes the terminal fittings 90 each having the tab 91, and the hood portion 20 inside which the tabs 91 protrude. The hood portion 20 includes the first latching portion 32 and the second latching portion 33 having shapes capable of being locked to each other. The first latching portion 32 protrudes forward beyond the opening edge on the first surface 39 of the hood portion 20. The first latching portion 32 and the second latching portion 33 are located at positions symmetrical with respect to a point in a front view of the hood portion 20.

The connector unit 60 of this Embodiment 1 is constituted of two connectors 10A and 10B of the same type, and each of the two connectors 10A and 10B includes the terminal fittings 90 each having the tab 91, and the hood portion 20 inside which the tabs 91 protrude. Out of the two connectors 10A and 10B, one connector 10A includes, on the hood portion 20, the first latching portion 32 protruding forward beyond the opening edge on the front surface 39 of the hood portion 20, and the other connector 10B includes the second latching portion 33. In a state in which the opening edges of the two connectors 10A and 10B are abutted against each other, the first latching portion 32 of the one connector 10A is locked to the second latching portion 33 of the other connector 10B.

For example, at the time of transfer or the like during a harness production process, when the opening edges of the two connectors 10A and 10B are abutted against each other, the first latching portion 32 of the one connector 10A can be locked to the second latching portion 33 of the other connector 10B. This makes it possible to couple the two connectors 10A and 10B to each other. The tabs 91 are disposed inside the hood portions 20 of the coupled connectors 10A and 10B in a state in which the tabs 91 are protected from foreign matter from the outside. Accordingly, with the configuration above, the tabs 91 can be protected even if the connector 10 does not include the moving plate. Since the connector 10 does not include the moving plate, the cost can be accordingly reduced, and this configuration is also applicable to a small-sized connector.

In this Embodiment 1, the first latching portion 32 has a protruding shape that protrudes from the front surface 39 (opening edge) of the hood portion 20, and the second latching portion 33 is formed in the front surface 39 of the hood portion 20 and has a recessed shape to which the first latching portion 32 can be fitted. With this configuration, when the first latching portion 32 and the second latching portion 33 are formed, it is not necessary to process elastic locks and the like, and the processability is excellent. Also, the opening edges of the two connectors 10A and 10B can be easily abutted against each other.

In this Embodiment 1, the press-fitting ribs 35 with a shape capable of coming into contact with the interior circumferential surface of the second latching portion 33 are formed on the exterior circumferential surface of the first latching portion 32. With this configuration, the force with which the first latching portion 32 and the second latching portion 33 are locked (coupled) to each other can be improved without complicating the shapes of the first latching portion 32 and the second latching portion 33.

In this Embodiment 1, a plurality of pairs of one first latching portion 32 and one second latching portion 33 are provided, and the first latching portion 32 and the second latching portion 33 in each pair are located at positions symmetrical about the center C1 of the opening of the hood portion 20 with the center C1 being a rotation center. With this configuration, the reliability with which the two connectors 10A and 10B remain coupled to each other can be improved when the opening edges of the connectors 10A and 10B are abutted against each other.

In addition, in this Embodiment 1, the first latching portions 32 are aligned in the left-right direction on the front surface 39 of the upper wall portion 22 of the hood portion 20, and the second latching portions 33 are aligned in the left-right direction on the front surface 39 of the lower wall portion 23 of the hood portion 20. With this configuration, an operator can easily recognize the orientation of the connector 10 with respect to the vertical direction by checking that the first latching portions 32 and the second latching portions 33 are located on the upper wall portion 22 and the lower wall portion 23 of the hood portion 20, respectively. As a result, it is possible to change the orientation of the connector 10 to the corresponding orientation and fit it to a counterpart connector, thus making it possible to speed up the fitting operation.

### Embodiment 2

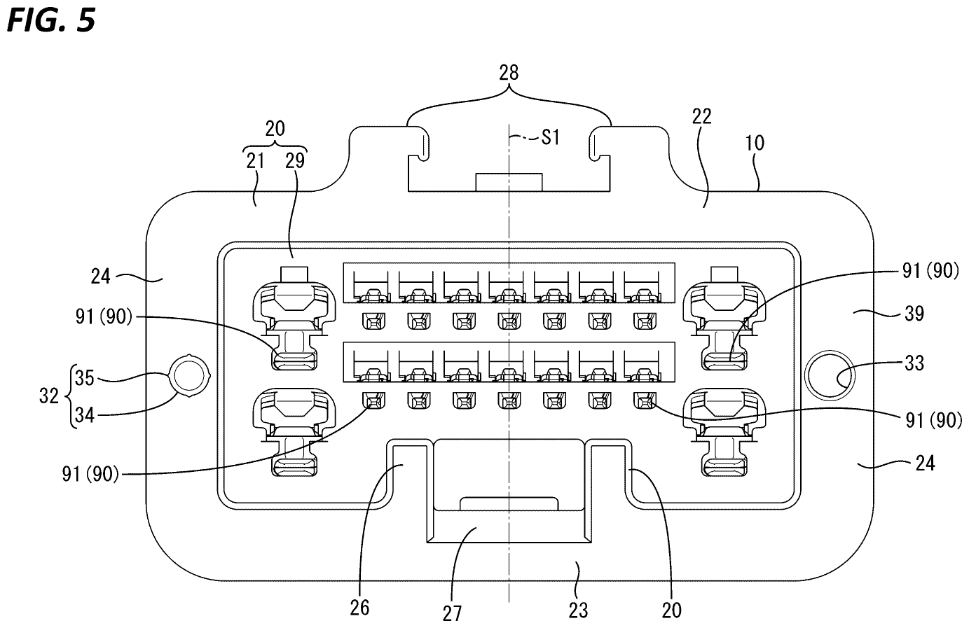

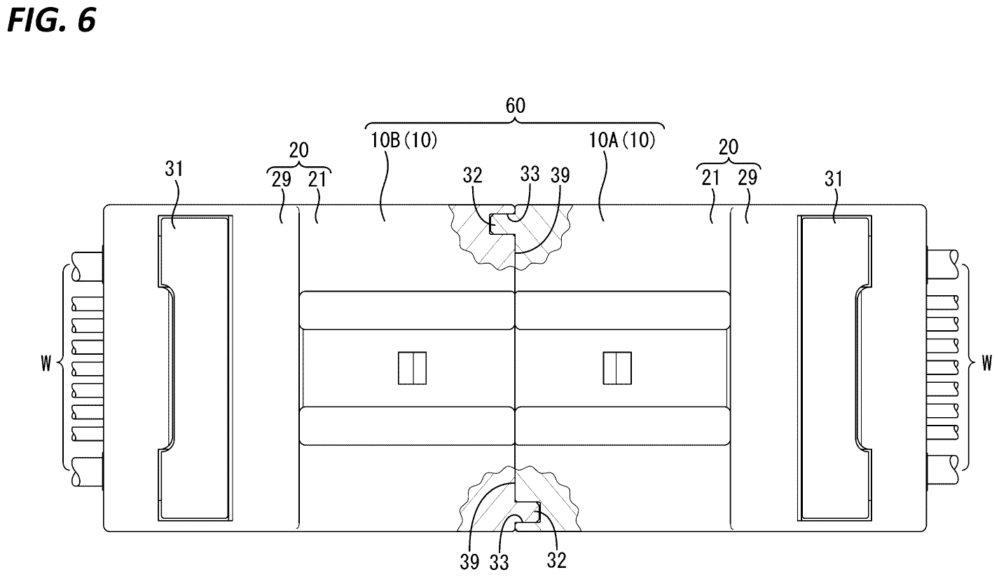

As shown in FIGS. 5 and 6, a connector 10 of Embodiment 2 differs from Embodiment 1 above in the arrangement of the first latching portion 32 and the second latching portion 33. The other configurations are the same as those of Embodiment 1above, and configurations identical or equivalent to those of Embodiment 1 above (encompassing the cases where the arrangements are changed) are denoted by identical reference numerals, and redundant descriptions are omitted.

The connector 10 is provided with one first latching portion 32 and one second latching portion 33. As shown in FIG. 5, the first latching portion 32 protrudes from the front surface 39 of one of the two side wall portions 24 of the hood portion 20. The second latching portion 33 is recessed in the front surface 39 of the other of the two side wall portions 24 of the hood portion 20.

The height positions of the first latching portion 32 and the second latching portion 33 are the same as those of the central portions in the vertical direction of the two side wall portions 24. The first latching portion 32 and the second latching portion 33 are located as a pair at positions symmetrical with respect to a symmetry axis S1 passing through the center in the left-right direction of the opening of the hood portion 20.

At the time of transfer or the like during a harness production process, two connectors 10A and 10B having the structure above are disposed with the openings thereof facing each other. Next, the front surfaces 39, which are the opening edges, of the hood portions 20 of the connectors 10A and 10B are abutted against each other. Then, as shown in FIG. 6, the first latching portion 32 of the one connector 10A is fitted into the second latching portion 33 of the other connector 10B, and the first latching portion 32 of the other connector 10B is fitted into the second latching portion 33 of the one connector 10A. As a result, a connector unit 60 is formed in which the connectors 10A and 10B are locked to each other in the state in which the front surfaces 39 of the hood portions 20 come into face-to-face contact with each other, and the connectors 10A and 10B remain coupled to each other.

With this Embodiment 2, similarly to Embodiment 1 above, the tabs 91 disposed inside the hood portions 20 of the connectors 10A and 10B are protected from foreign matter from the outside. Since the connector 10 does not include the moving plate, the cost can be accordingly reduced, and this configuration is also applicable to a small-sized connector.

### Embodiment 3

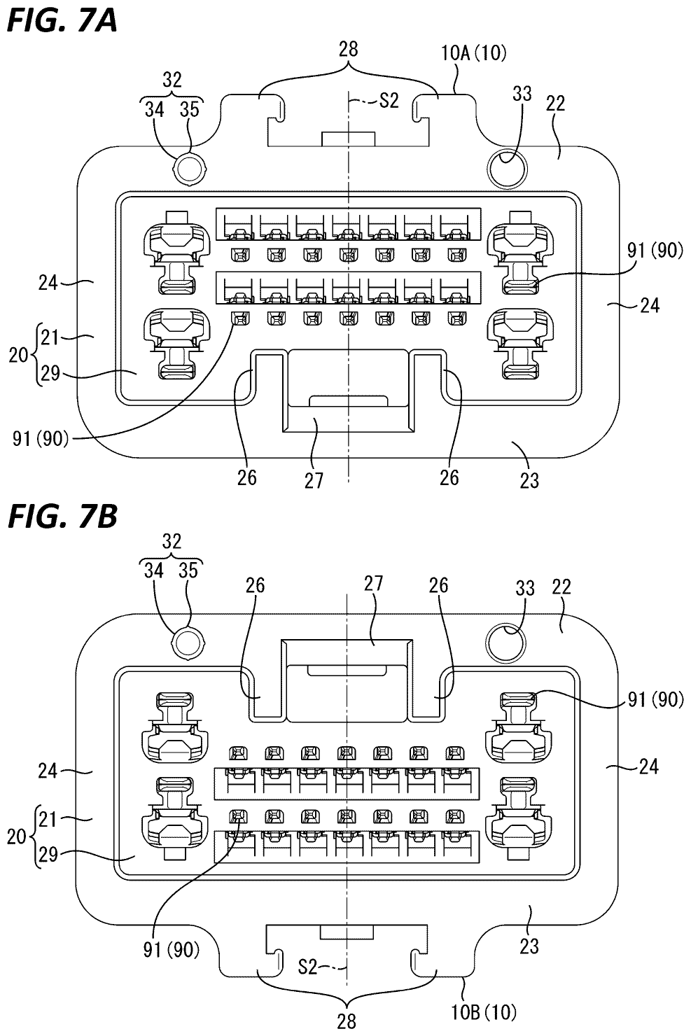

As shown in FIGS. 7A and 7B, a connector 10 of Embodiment 3 is configured as a connector of a different type that differs from the connector 10 of Embodiment 1 above in the arrangement of the first latching portion 32 and the second latching portion 33 and that has a different shape as a whole. The other configurations are the same as those of Embodiment 1 above, and configurations identical or equivalent to those of Embodiment 1 above (encompassing the cases where the arrangements are changed) are denoted by identical reference numerals, and redundant descriptions are omitted.

Two connectors 10A and 10B that are of the different type as described above are coupled to each other to form a connector unit 60. The basic structures of the two connectors 10A and 10B are the same as that of the connector 10 of Embodiment 1 above. As shown in FIG. 7A, a first connector 10A, which is one of the two connectors 10A and 10B, is provided with a rail portion 28 on the upper wall portion 22, and a pair of guiding ribs 26 and a locking portion 27 on the lower wall portion 23. In the first connector 10A, the first latching portion 32 and the second latching portion 33 are located as a pair at positions spaced apart from each other in the left-right direction on the front surface 39 of the upper wall portion 22 of the hood portion 20. The first latching portion 32 and the second latching portion 33 are located as a pair at positions symmetrical with respect to a symmetry axis S2 passing through the center in the left-right direction of the opening of the hood portion 20.

As shown in FIG. 7B, a second connector 10B, which is the other of the two connectors 10A and 10B, is provided with a pair of guiding ribs 26 and a locking portion 27 on the upper wall portion 22, and a rail portion 28 on the lower wall portion 23. In the second connector 10B, similarly to the first connector 10A, the first latching portion 32 and the second latching portion 33 are located as a pair at positions spaced apart from each other in the left-right direction on the front surface 39 of the upper wall portion 22 of the hood portion 20. The first latching portion 32 and the second latching portion 33 are located as a pair at positions symmetrical with respect to a symmetry axis S2 passing through the center in the left-right direction of the opening of the hood portion 20. In other words, the connector 10A and the connector 10B are connectors of different types that differ in the arrangement of the first latching portion 32 and the second latching portion 33.

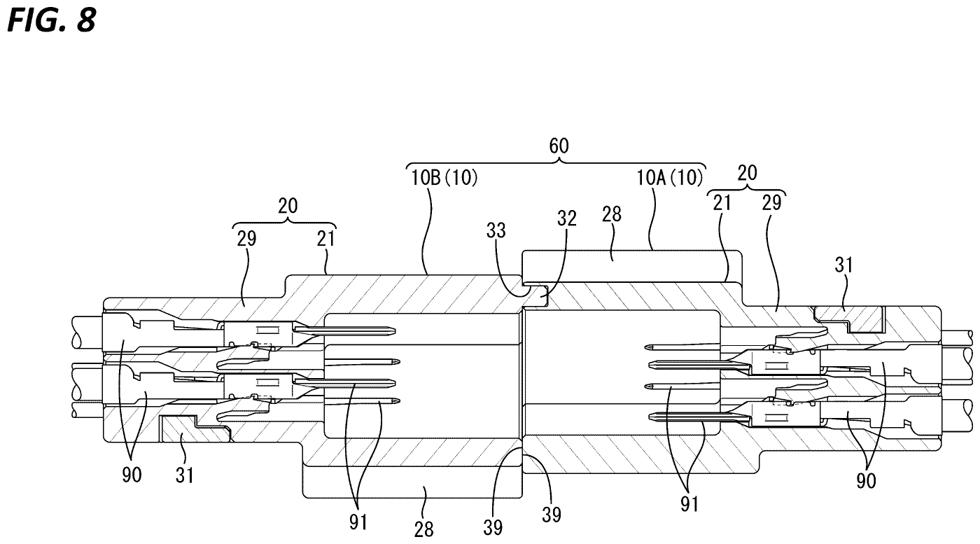

At the time of transfer or the like during a harness production process, the first connector 10A and the second connector 10B are disposed with the openings thereof facing each other. Next, as shown in FIG. 8, the front surfaces 39, which are the opening edges, of the hood portions 20 of the first connector 10A and the second connector 10B are abutted against each other. Then, the first latching portion 32 of the first connector 10A is fitted into the second latching portion 33 of the second connector 10B, and the first latching portion 32 of the second connector 10B is fitted into the second latching portion 33 of the first connector 10A. As a result, a connector unit 60 is formed in which the first connector 10A and the second connector 10B are locked to each other in the state in which the front surfaces 39 of the hood portions 20 come into face-to-face contact with each other, and the first connector 10A and the second connector 10B remain coupled to each other.

With this Embodiment 3, similarly to Embodiment 1 above, the tabs 91 disposed inside the hood portions 20 of the first connector 10A and the second connector 10B are protected from foreign matter from the outside. Since the connector 10 does not include the moving plate, the cost can be accordingly reduced, and this configuration is also applicable to a small-sized connector.

### Other Embodiments of the Present Disclosure

Embodiments 1 to 3 above disclosed herein are exemplary in all respects, and should be construed as being not limitative.

In Embodiments 1 to 3 above, the press-fitting ribs 35 protrude from the exterior circumferential surface of the first latching portion. However, in other embodiments, the press-fitting ribs may be formed on the interior circumferential surface of the second latching portion. The press-fitting ribs may include those protruding from the exterior circumferential surface of the first latching portion and those formed on the interior circumferential surface of the second latching portion.

In Embodiments 1 to 3 above, the first latching portion 32 protrudes from the front surface 39 of the hood portion 20. However, in other embodiments, it is sufficient that the first latching portion includes a portion that extends with a rib-like shape on the outer periphery of the hood portion and protrudes forward beyond the front surface of the hood portion. In short, it is sufficient that the leading end portion in the protrusion direction of the first latching portion is located forward of the front surface of the hood portion.

In Embodiments 1 to 3 above, the first latching portion 32 and the second latching portion 33 are formed on any of the upper wall portion, the lower wall portion, and the left and right side wall portions of the hood portion. However, in other embodiments, the first latching portion and the second latching portion may be formed at a corner portion of the hood portion.

In Embodiments 1 to 3 above, the first latching portion 32 has a protruding shape that protrudes from the front surface 39 of the hood portion 20, and the second latching portion 33 is formed in the front surface 39 of the hood portion 20 and has a recessed shape to which the first latching portion 32 can be fitted. However, in other embodiments, the first latching portion may be configured as an elastic locking portion having a locking hole or a locking hook, and the second latching portion may have a shape capable of being elastically hooked onto the first latching portion.

In Embodiments 2 and 3 above, the first latching portion 32 and the second latching portion 33 are located as a pair at positions symmetrical with respect to the symmetry axis S1 or S2 passing through the center in the left-right direction of the opening of the hood portion 20. However, in other embodiments, the first latching portion and the second latching portion may be located as a pair at positions symmetrical with respect to a symmetry axis passing through the center in the vertical direction of the opening of the hood portion.

In Embodiment 1 above, two pairs of one first latching portion and one second latching portion are provided, and the first latching portion and the second latching portion in each pair are located at a pair of positions on the hood portion symmetrical about a point. In Embodiment 2, a pair of one first latching portion and one second latching portion are provided, and the first latching portion and the second latching portion are located at a pair of positions on the hood portion symmetrical with respect to a line. However, in other embodiments, three or more pairs of one first latching portion and one second latching portion may be provided, with the first latching portion and the second latching portion in each pair being located at a pair of positions symmetrical about a point or with respect to a line.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a terminal fitting with a tab; and
a hood portion inside which the tab protrudes,
wherein the hood portion includes a first latching portion and a second latching portion having shapes capable of being locked to each other,
the first latching portion includes a portion protruding forward beyond an
the first latching portion and the second latching portion are located at positions symmetrical about a point or with respect to a line when the hood portion is viewed from a front side.

2. The connector according to claim 1,
wherein the first latching portion has a protruding shape that protrudes from the opening edge, and
the second latching portion is formed at the opening edge and has a recessed shape to which the first latching portion is fittable.

3. The connector according to claim 2,
wherein at least either one of an exterior circumferential surface of the first latching portion and an interior circumferential surface of the second latching portion is provided with a press-fitting rib having a shape capable of coming into contact with the other one.

4. The connector according to claim 1,
wherein a plurality of pairs of one first latching portion and one second latching portion are provided, and the first latching portion and the second latching portion in each pair are located at positions symmetrical about a center of the opening with the center being a rotation center.

5. The connector according to claim 4,
wherein the first latching portion is located on an upper side, a lower side, a left side, or a right side of the opening edge, and
the second latching portion is located on a side opposite to the side on which the opening edge is located.

6. A connector unit comprising two connectors of one type or different types,
wherein each of the two connectors includes:
a terminal fitting with a tab; and
a hood portion inside which the tab protrudes,
one connector of the two connectors includes, on the hood portion, a first latching portion having a portion protruding forward beyond an opening edge on a front surface of the hood portion, and the other connector includes a second latching portion, and
in a state in which opening edges of the two connectors are abutted against each other, the first latching portion of the one connector is locked to the second latching portion of the other connector.
